(19) United States
(12) Patent Application Publication
(10) Pub. No.: US 2024/0347045 A1
(43) Pub. Date: Oct. 17, 2024

(54) INFORMATION PROCESSING DEVICE, INFORMATION PROCESSING METHOD, AND PROGRAM

(71) Applicant: Sony Group Corporation, Tokyo (JP)

(72) Inventor: Yuuji TAKIMOTO, Kanagawa (JP)

(73) Assignee: Sony Group Corporation, Tokyo (JP)

(21) Appl. No.: 18/683,064

(22) PCT Filed: Mar. 17, 2022
(86) PCT No.: PCT/JP2022/012271

§ 371 Date: Feb. 12, 2024

(30) Foreign Application Priority Data
Aug. 24, 2021 (JP) 2021-136303

(51) Int. Cl. G10L 15/08; G06F 3/14; G06F 40/169

(52) U.S. Cl. CPC G10L 15/083; G06F 3/1454; G06F 40/169; G10L 2015/088

(57) ABSTRACT

Provided are an information processing device, an information processing method, and a program that enable a person to easily grasp which part of a document another person is uttering about when the person and the other person perform conversation while referring to a common document. The information processing device includes a supplement processing unit that adds supplement information to a document displayed on an utterer terminal device used by an utterer and a listener terminal device used by a listener who performs conversation with the utterer in accordance with information regarding the conversation or the document.

### TECHNICAL FIELD

The present technology relates to an information processing device, an information processing method, and a program.

### BACKGROUND ART

In recent years, with the progress of Internet technology, changes in social situations, and the like, it has become widespread that a person and another person perform conversation (meeting, talking, explanation of information, inquiry and answer, or the like) by using a video call on the Internet.

As a technology related to the conversation between the person and the other person using the Internet, for example, there is an interactive business support system (Patent Document 1) that supports business of responding to an inquiry from a customer.

### CITATION LIST

### Patent Document

Patent Document 1: Japanese Patent Application Laid-Open No. 2019-207647

### SUMMARY OF THE INVENTION

### Problems to be Solved by the Invention

There is a problem that it is difficult to understand where the explanation is in a document when the document is displayed and explained on terminal devices of each other in the video call. Furthermore, there is also a problem that, when the person concentrates on understanding the content or the like, in a case where the other person utters about a content that is not written in the document, the person does not notice the fact and searches for which part in the document the other person is uttering.

The present technology has been made in view of such a point, and an object of the present technology is to provide an information processing device, an information processing method, and a program that enable a person to easily grasp which part of a document another person is uttering about when the person and the other person perform conversation while referring to a common document.

### Solutions to Problems

In order to solve the above-described problem, a first technology is an information processing device including a supplement processing unit that adds supplement information to a document displayed on an utterer terminal device used by an utterer and a listener terminal device used by a listener who performs conversation with the utterer in accordance with information regarding the conversation or the document.

Furthermore, a second technology is an information processing method including adding supplement information to a document displayed on an utterer terminal device used by an utterer and a listener terminal device used by a listener who performs conversation with the utterer in accordance with information regarding the conversation or the document.

Moreover, a third technology is a program causing a computer to execute an information processing method of adding supplement information to a document displayed on an utterer terminal device used by an utterer and a listener terminal device used by a listener who performs conversation with the utterer in accordance with information regarding the conversation or the document.

### BRIEF DESCRIPTION OF DRAWINGS

FIG. 1 is a block diagram illustrating a configuration of a conversation system 10.

FIG. 2 is a diagram illustrating an outline of conversation between an utterer and a listener.

FIG. 3 is a block diagram illustrating configurations of an utterer terminal device 100 and a listener terminal device 200.

FIG. 4 is a block diagram illustrating a configuration of an information processing device 300 according to a first embodiment.

FIG. 5 is a block diagram illustrating a configuration of a server device.

FIG. 6 is a flowchart illustrating processing of the information processing device 300 according to the first embodiment.

FIG. 7 is a diagram illustrating a specific example of addition of utterance position supplement information.

FIG. 8 is a diagram illustrating a specific example of addition of utterance position supplement information and addition of emphasis supplement information.

FIG. 9 is a diagram illustrating a specific example of addition of utterance content information.

FIG. 10 is a block diagram illustrating a configuration of an information processing device 300 according to a second embodiment.

FIG. 11 is a flowchart illustrating processing of the information processing device 300 according to the second embodiment.

FIG. 12 is a diagram illustrating a specific example of addition of display range supplement information.

FIG. 13 is a block diagram illustrating a configuration of an information processing device 300 according to a third embodiment.

FIG. 14 is a flowchart illustrating processing of the information processing device 300 according to the third embodiment.

FIG. 15 is a diagram illustrating a specific example of addition of notification supplement information.

FIG. 16 is a diagram illustrating a specific example of addition of notification supplement information.

### MODE FOR CARRYING OUT THE INVENTION

Hereinafter, embodiments of the present technology will be described with reference to the drawings. Note that, the description will be made in the following order.
<1. First Embodiment>
[1-1. Configuration of Conversation System 10]
[1-2. Configurations of Utterer Terminal Device 100 and Listener Terminal Device 200]
[1-3. Configuration of Information Processing Device 300]
[1-4. Processing in Information Processing Device 300]
<2. Second Embodiment>
[2-1. Configuration of Information Processing Device 300]
[2-2. Processing in Information Processing Device 300]
<3. Third Embodiment>
[3-1. Configuration of Information Processing Device 300]
[3-2. Processing in Information Processing Device 300]
<4. Modifications>

### 1. First Embodiment

### [1-1. Configuration of Conversation System 10]

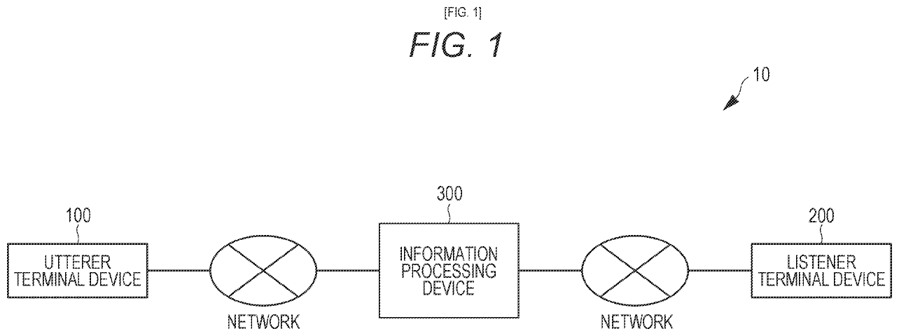

First, a configuration of a conversation system 10 will be described with reference to FIG. 1. The conversation system 10 includes an utterer terminal device 100 used by a person who speaks (referred to as an utterer), a listener terminal device 200 used by a person who is a conversation partner of the utterer and listens to an utterance content of the utterer (referred to as a listener), and an information processing device 300 that performs processing in the present technology.

The utterer terminal device 100 and the information processing device 300 are connected via a network, and the listener terminal device 200 and the information processing device 300 are also connected via a network.

The network may be wired or wireless. Note that, although one utterer terminal device 100 and one listener terminal device 200 are illustrated in FIG. 1, a plurality of utterer terminal devices 100 and a plurality of listener terminal devices 200 may be connected to the information processing device 300.

The utterer terminal device 100 is used for displaying a document viewed by the utterer in the conversation, receiving an input from the utterer, and transmitting voice data that is the utterance content of the utterer to the information processing device 300.

The listener terminal device 200 is used for displaying a document viewed by the listener in the conversation, receiving an input from the listener, and transmitting voice data which is an utterance content of the listener and video data obtained by imaging a state of the listener to the information processing device 300.

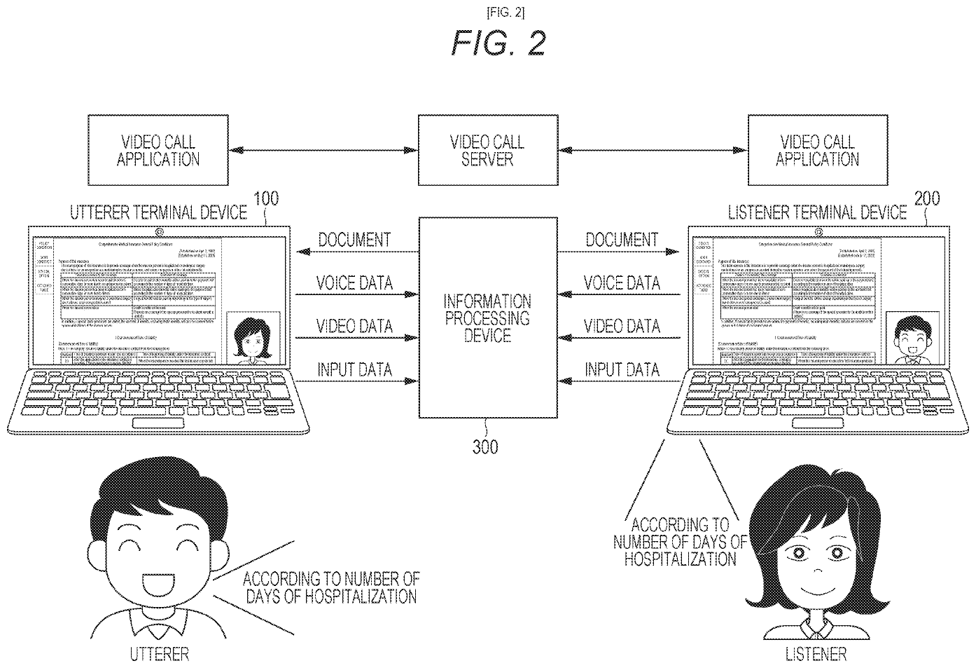

Here, an outline of the conversation between the utterer and the listener in the conversation system 10 will be described with reference to FIG. 2.

The utterer terminal device 100 and the listener terminal device 200 are connected by an existing video call application. With a display function of the video call application, a document transmitted from the information processing device 300 is displayed on the utterer terminal device 100 and the listener terminal device 200. Note that, the display of the document may be implemented by an application or a function different from that of the video call application. Any application or function may be used for display as long as a common document is displayed on the utterer terminal device 100 and the listener terminal device 200.

Furthermore, when the utterer makes an utterance, voice data acquired by a microphone 107 included in the utterer terminal device 100 is output from the listener terminal device 200 by the video call application, and thus, the listener can listen to voice of the utterer. The utterer makes an utterance to the listener while referring to the displayed document by using the function of the video call application. The listener can listen to the utterance of the utterer while viewing the displayed document.

Furthermore, voice data including the utterance content of the utterer, video data obtained by imaging a state of the utterer, input data input by the utterer using the utterer terminal device 100, and the like are transmitted from the utterer terminal device 100 to the information processing device 300.

Furthermore, voice data including the utterance content of the listener, video data obtained by imaging the state of the listener, input data input by the listener using the utterer terminal device 100, and the like are transmitted from the listener terminal device 200 to the information processing device 300.

Note that, in FIG. 2, although it has been described that a video call server and the information processing device 300 are separately provided, the video call server may have a function as the information processing device 300. The processing by the information processing device 300 may be provided as being integrated with processing performed by the video call application.

The document includes a plurality of sentences including a plurality of characters. The document may be any document such as a material, a novel, a paper, a cartoon, an essay, a poetic, a Japanese poem, a source code, data, an official document, a private document, a security, or a book as long as the document represents a substantial content with characters. Furthermore, the document may include a figure, an illustration, a table, a graph, a photograph, and the like in addition to a character string.

A file format of the document may be any format as long as the document is displayed on the terminal device and can be viewed by the utterer and the listener, such as Portable Document Format (PDF), Joint Photographic Experts Group (JPEG), text files of various formats, files created by document creation software, files created by spreadsheet software, and files created by presentation software.

### [1-2. Configurations of Utterer Terminal Device 100 and Listener Terminal Device 200]

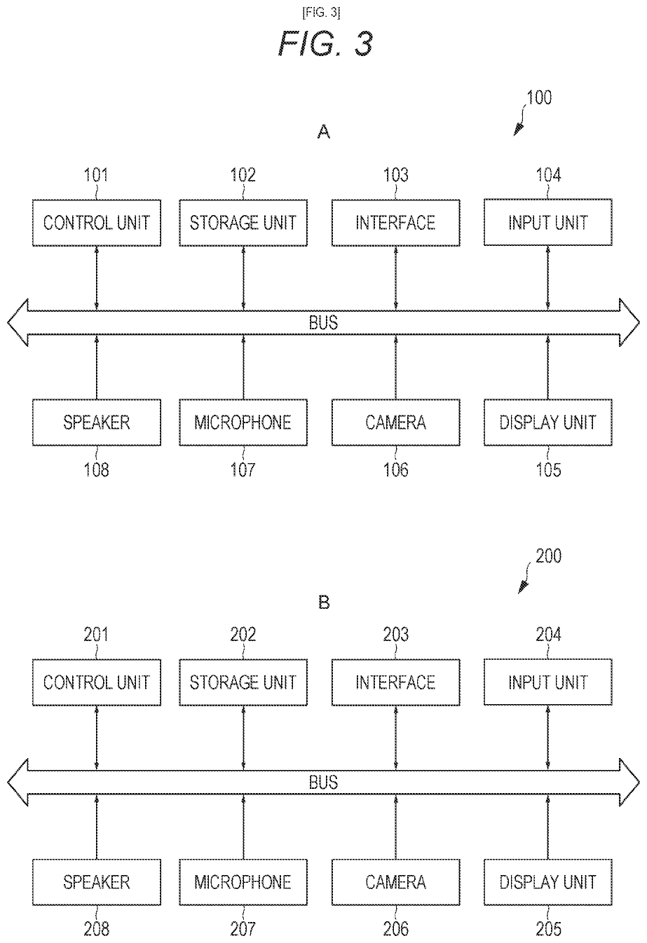

Next, a configuration of the utterer terminal device 100 will be described with reference to FIG. 3A. As illustrated in FIG. 3A, the utterer terminal device 100 includes at least a control unit 101, a storage unit 102, an interface 103, an input unit 104, a display unit 105, a camera 106, a microphone 107, and a speaker 108.

The control unit 101 includes a central processing unit (CPU), a random access memory (RAM), a read only memory (ROM) and the like. The CPU executes various types of processing according to a program stored in the ROM and issues commands, and thus, the entire utterer terminal device 100 and the units thereof are controlled.

The storage unit 102 is, for example, a large-capacity storage medium such as a hard disk or a flash memory. The storage unit 102 stores various applications, data, and the like used by the utterer terminal device 100.

The interface 103 is an interface with the information processing device 300 and the Internet. The interface 103 may include a wired or wireless communication interface. Furthermore, more specifically, the wired or wireless communication interface may include cellular communication such as 3TTE, Wi-Fi, Bluetooth (registered trademark), near field communication (NFC), Ethernet (registered trademark), high-definition multimedia interface (HDMI (registered trademark)), universal serial bus (USB) and the like. Furthermore, in a case where the utterer terminal device 100 is implemented by being distributed to a plurality of devices, the interface 103 may include different types of interfaces for the devices. For example, the interface 103 may include both a communication interface and an interface in a device.

The input unit 104 is used by the utterer to input information, give various instructions, and the like to the utterer terminal device 100. When a user performs an input on the input unit 104, a control signal corresponding to the input is created and supplied to the control unit 101. The control unit 101 performs various types of processing corresponding to the control signal. The input unit 104 includes, in addition to physical buttons, a touch panel, a touch screen integrally constructed with a monitor, and the like.

The display unit 105 is a display device such as a display that displays a document, an image, a video, a UI of the video call application, and the like.

The camera 106 includes a lens, an imaging element, a video signal processing circuit, and the like, and is used for imaging a live video or an image transmitted from the utterer terminal device 100 to the listener terminal device 200 in a case where a video call is performed.

The microphone 107 is used by the utterer to input voice to the utterer terminal device 100. The microphone 107 is also used as a voice input device in a voice call or a video call with the listener terminal device 200.

The speaker 108 is a voice output device that outputs voice.

The utterer terminal device 100 is constructed as described above. Note that, since a configuration of the listener terminal device 200 illustrated in FIG. 3B is similar to the configuration of the utterer terminal device 100, the description thereof will be omitted.

Specific examples of the utterer terminal device 100 and the listener terminal device 200 include a personal computer, a smartphone, a tablet terminal, and a wearable device. In a case where there is a program necessary for the processing according to the present technology, the program may be installed in advance in the utterer terminal device 100 or the utterer terminal device 100, or may be installed by the utterer or the listener by being download and distributed on a storage medium or the like.

Note that, the camera 106, the microphone 107, and the speaker 108 are not included in the utterer terminal device 100 itself, and may be external devices connected to the utterer terminal device 100 in a wired or wireless manner. The same applies to the camera 206, the microphone 207, and the speaker 208 in the listener terminal device 200.

### [1-3. Configuration of Information Processing Device 300]

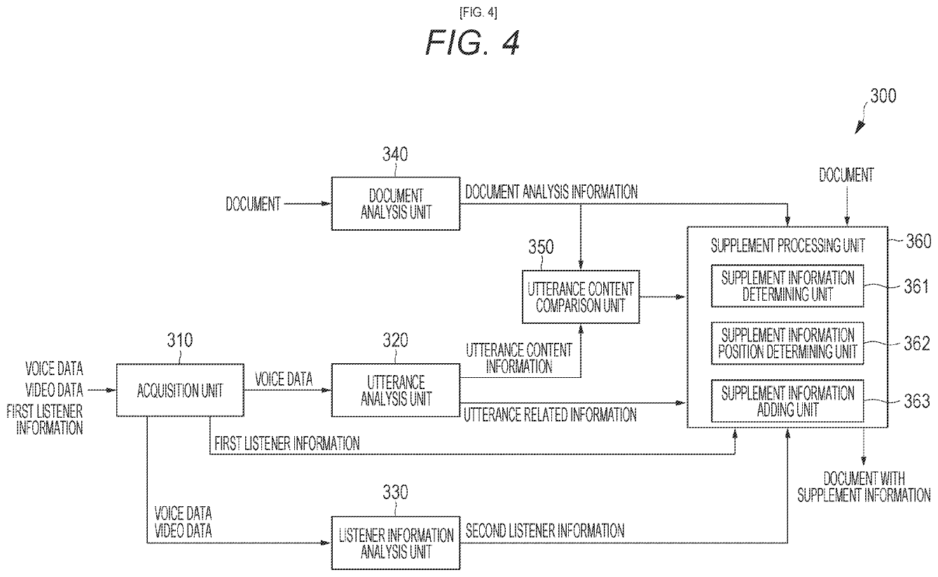

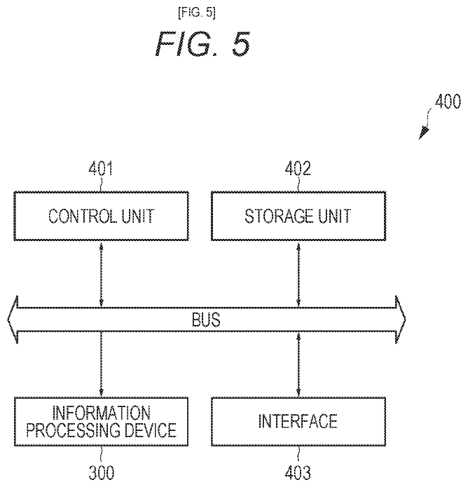

A configuration of the information processing device 300 will be described with reference to FIG. 4. The information processing device 300 operates in, for example, a server device 400 illustrated in FIG. 5. The server device 400 includes at least a control unit 401, a storage unit 402, and an interface 403. Since these units are similar to those included in the utterer terminal device 100, the description thereof will be omitted.

The information processing device 300 includes an acquisition unit 310, an utterance analysis unit 320, a listener information analysis unit 330, a document analysis unit 340, an utterance content comparison unit 350, and a supplement processing unit 360.

The acquisition unit 310 acquires various types of data and information transmitted from the utterer terminal device 100 and the listener terminal device 200. Examples of the data and information acquired by the acquisition unit 310 include the voice data of the utterer, the voice data of the listener, the video data of the listener, and first listener information. The acquisition unit 310 supplies the voice data to the utterance analysis unit 320, supplies the first listener information to the supplement processing unit 360, and supplies the video data to the listener information analysis unit 330.

The voice data of the utterer is voice data generated by collecting voice uttered by the utterer with the microphone 107. The voice data of the listener is voice data generated by collecting voice uttered by the listener with the microphone 207. The video data of the listener is video data generated by imaging the state of the listener with the camera 206. The first listener information is information regarding the listener that can be acquired in advance, and is, for example, a name, an age, an occupation, a sex, a hobby, a family structure, presence or absence of chronic diseases of the listener and the family, and the like.

The utterance analysis unit 320 analyzes the voice data transmitted from the utterer terminal device 100 to acquire utterance content information and utterance related information of the utterer. Furthermore, the utterance analysis unit 320 may analyze the voice data transmitted from the listener terminal device 200 to acquire the utterance content information and the utterance related information of the listener.

The utterance content information is information representing the content uttered by the utterer in characters. The utterance related information is information other than utterance content information related to the utterance obtained by voice analysis, such as the magnitude of the voice, the tone of the voice, and the speed of the utterance of the utterer.

The listener information analysis unit 330 acquires second listener information by performing predetermined voice analysis processing on the voice data acquired by the microphone 207 or performing predetermined video analysis processing on the video data imaged by the camera 206. The second listener information is information regarding the listener that can be acquired in real time in the conversation between the utterer and the listener. The second listener information is, for example, the utterance content of the listener, a behavior of the listener, a reaction of the listener, an expression of the listener, and the like.

The document analysis unit 340 analyzes the document displayed on the utterer terminal device 100 and the listener terminal device 200 to acquire document analysis information. The document analysis information is, for example, information such as a structure of a sentence in the document, a subject, a predicate, an object, a size of a character, a color of a character, a font of a character, and presence or absence of decoration (underline or the like) for a character. The document analysis unit 340 supplies the document analysis information to the utterance content comparison unit 350 and the supplement processing unit 360.

Furthermore, the document analysis unit 340 may include information regarding the document input by the utterer in the document analysis information. For example, as the information regarding the document input by the utterer, there are an important portion, a portion that is statistically easy to be misunderstood, and a portion that changes speech.

The utterance content comparison unit 350 compares and determines whether or not the utterance content of the utterer corresponds to the content of the document. The comparison determination is performed, for example, for every sentence. When the document is analyzed in advance by the document analysis unit 340, since the structure, the subject, the predicate, the object, and the like of the sentence in the document can be grasped, the determination is performed even in units of such words. As will be described in detail later, “the utterance content of the utterer corresponds to the content of the document” includes a case where a part of a predetermined amount coincides in addition to a case where the utterance content of the utterer completely coincides the content of the document.

The supplement processing unit 360 adds supplement information to the document to creates a document with supplement information. The created document with supplement information is transmitted to the utterer terminal device 100 and the listener terminal device 200 and is displayed on each terminal device. The supplement processing unit 360 includes a supplement information determining unit 361, a supplement information position determining unit 362, and a supplement information adding unit 363.

The supplement information determining unit 361 determines which information is added, as supplement information, to the document. In the first embodiment, which information of utterance position supplement information, emphasis supplement information, and utterance content supplement information is added, as the supplement information, to the document is determined.

The utterance position supplement information is information indicating a character string in the document the utterance content of the utterer corresponds to in a case where the utterance content of the utterer corresponds to the content of the document.

Consequently, the listener can grasp which part of the document the utterer is uttering about. The emphasis supplement information is information for emphasizing a character string in the document. Consequently, the listener can grasp which part of the document is important. The utterance content supplement information is information for indicating the utterance content of the utterer, which is not described in the document, to the listener with characters in a case where the utterance content of the utterer does not correspond to the content of the document. Therefore, the listener can grasp the utterance content of the utterer, which is not described in the document, with characters.

The supplement information position determining unit 362 determines which part in the document the supplement information is to be added.

The supplement information adding unit 363 adds, to the document, the supplement information determined by the supplement information determining unit 361 and the supplement information position determining unit 362 to create a document with supplement information.

The information processing device 300 has the above-described configuration. The information processing device 300 may operate in an electronic device such as a cloud, a smartphone, or a personal computer in addition to the server device 400. Furthermore, the information processing device 300 may be implemented by causing a computer to execute a program. The program may be installed in a server, a cloud, or a terminal device in advance, or may be installed by an operator by being downloaded and distributed on a storage medium or the like.

Note that, the analysis processing in the utterance analysis unit 320 and the document analysis unit 340 may be performed in the utterer terminal device 100. In this case, the utterer terminal device 100 transmits the analysis result to the information processing device 300.

### [1-4. Processing in Information Processing Device 300]

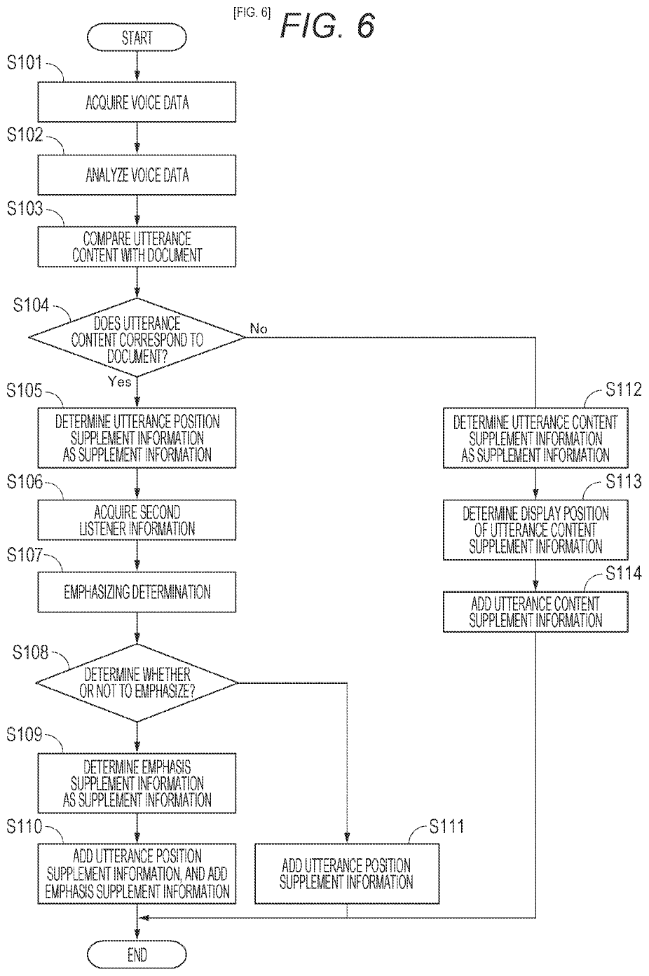

Next, processing in the information processing device 300 will be described with reference to FIG. 6.

Note that, before the processing illustrated in FIG. 6, a document in an initial state input to the information processing device 300 is transmitted to the utterer terminal device 100 and the listener terminal device 200, and the document in the initial state is displayed on the utterer terminal device 100 and the listener terminal device 200. The document in the initial state is a document in a state where the supplement information is not added by the information processing device 300. Furthermore, the analysis processing is performed on the document by the document analysis unit 340 in advance, and document analysis information is acquired.

Moreover, the acquisition unit 310 acquires the first listener information in advance. The first listener information may be transmitted from the listener terminal device 200 to the information processing device 300 by the listener, or the first listener information may be acquired in advance by the utterer through an interview, questionnaire, or the like with the listener, and may be transmitted from the utterer terminal device 100 to the information processing device 300.

When the utterer makes an utterance related to the document, the voice data acquired by the microphone 107 is transmitted from the utterer terminal device 100 to the information processing device 300. In step S101, the acquisition unit 310 acquires the voice data. The acquisition unit 310 supplies the acquired voice data to the utterance analysis unit 320.

Subsequently, in step S102, the utterance analysis unit 320 analyzes the voice data of the utterer, and acquires the utterance content information and the utterance related information of the utterer. In the analysis of the voice data, first, the character string as the utterance content is recognized from the voice data by a known voice recognition function.

The utterance analysis unit 320 performs morphological analysis on the recognized utterance content. The morpheme analysis is processing of dividing the utterance content into morphemes, which are minimum units having meanings in language, on the basis of information such as grammar of a target language and a part of speech of a word, and discriminating the part of speech and the like of each morpheme.

Furthermore, the utterance analysis unit 320 performs syntax analysis on the utterance content on which the morphological analysis is performed. The syntax analysis is processing of determining a relationship between words such as modifiers and modified words on the basis of grammars and syntax, and expressing the relationship by some data structure, schematization and the like.

Moreover, the utterance analysis unit 320 performs semantic analysis on the utterance content on the morphological analysis is performed. The semantic analysis is processing of determining a correct connection between a plurality of morphemes on the basis of the meaning of each morpheme. By the semantic analysis, a semantically correct syntax tree is selected from a plurality of patterns of syntax trees.

Note that, the syntax analysis and the semantic analysis can be implemented by machine learning, deep learning and the like.

Furthermore, the utterance analysis unit 320 acquires the utterance related information by measuring the magnitude of the voice of the utterer in the voice data, and measuring the speed of the utterance.

Subsequently, in step S103, the utterance content comparison unit 350 compares whether or not the utterance content information corresponds to the character string in the document on the basis of the syntax analysis result and the semantic analysis result.

In the comparison of whether or not the utterance content information corresponds to the character string in the document, for example, in a case where the utterance content information completely coincides the character string in the document, it is determined that the utterance content information corresponds to the character string in the document. Furthermore, even in a case where the utterance content information coincides the character string in the document by a predetermined number of characters or more, it may be determined that the utterance content corresponds to the character string in the document. Furthermore, in a case where the utterance content information does not coincide the character string in the document by the predetermined number of characters or more, it is determined that the utterance content information does not correspond to the character string in the document. The predetermined number of characters is, for example, half of one sentence.

As a result of the comparison, in a case where the utterance content information corresponds to the character string in the document, the processing proceeds from step S104 to step S105 (Yes in step S104).

Subsequently, in step S105, the supplement information determining unit 361 determines to add, as supplement information, the utterance position supplement information to the document. Moreover, the supplement information determining unit 361 determines a method for adding the utterance position supplement information.

The method for adding the utterance position supplement information includes changing the size, color, and font of characters in the document, and decorating characters in the document (for example, an underline is drawn, characters, figures, illustrations, and the like in the document are surrounded by a figure such as a circle, and the like). The supplement information determining unit 361 determines one of these methods as the method for adding the utterance position supplement information.

Subsequently, in step S106, the listener information analysis unit 330 analyzes the video data to acquire the second listener information.

Subsequently, in step S107, the supplement information determining unit 361 determines whether or not to add, to the document, the emphasis supplement information for emphasizing the character string in the document corresponding to the utterance content information. Whether or not to add the emphasis supplement information to the document can be determined by various methods, and can be determined on the basis of, for example, the utterance content information and the utterance related information.

For example, in a case where the magnitude of the voice of the utterer at the time of utterance is a predetermined value or more, it can be determined to add the emphasis supplement information to the document. The reason why the voice of the utterer is increased is that the utterance content is considered to be important.

Furthermore, in a case where the speed of the utterance of the utterer at the time of utterance is equal to or less than a predetermined speed, it can be determined to add the emphasis supplement information to the document. The reason why the utterer is slowly uttering is that the utterance content is considered to be important.

Furthermore, in a case where the utterer utters a specific keyword at the time of utterance, it is determined to add the emphasis supplement information to the document. As the keyword, for example, there are “important”, “valuable”, “please listen carefully”, “easy to make a mistake”, and “understood?”. This is because these keywords have high possibilities of being uttered together with important contents. Furthermore, in a case where the utterer utters these keywords, there is a possibility that the utterer is explaining while carefully checking whether or not the listener is understood. Note that, the keywords described herein are merely examples, and the keywords are not limited thereto, and the utterer, an operator of the conversation system, or the like may set the keywords in advance.

Furthermore, in a case where the utterer makes an input for designating a character string to be emphasized in the document through the input unit 104, it can be determined to add the emphasis supplement information to the document.

Furthermore, whether or not to add the emphasis supplement information to the document can be determined on the basis of the information regarding the listener.

As described above, the information regarding the listener includes the first listener information acquired in advance and the second listener information acquired in real time during the conversation.

For example, in a case where the document is a document regarding a life insurance contract and it can be grasped from the first listener information that the listener is a person under age or that there is a person with a specific disease in the family line of the listener, it is determined to add the emphasis supplement information to an item considered to have an influence on the contract.

Furthermore, in a case where the listener specifies that the listener utters the specific keyword from the second listener information acquired by performing the voice analysis on the voice data of the listener, it is determined to add the emphasis supplement information to the document to emphasize the character string corresponding to the utterance content information uttered by the utterer at a timing when the listener utters the keyword.

As the keyword, for example, there are “hmm”, “uh”, “I don't know”, and “please wait a minute”. These keywords are words generally uttered in a case where the listener does not understand, and it is considered that the listener does not understand the explanation of the utterer in a case where the listener has uttered these keywords. Portions that the listener would not understand are emphasized, and thus, the listener can easily understand.

Furthermore, in a case where it is detected from the video data that a nodding motion of the listener is shallow, it is determined to add the emphasis supplement information to the document to emphasize the character string corresponding to the utterance content uttered by the utterer at a timing when the listener nods. This is because it is considered that the listener does not understand in a case where the nodding motion of the listener is shallow. The portions that the listener would not understand are emphasized, and thus, the listener can easily understand.

The nodding motion of the listener can be detected by performing known posture detection processing on the video data and comparing a posture angle (bone position) with a predetermined threshold value.

Furthermore, in a case where a bothered expression of the listener is detected from the video data, it is determined to add the emphasis supplement information to the document to emphasize the character string corresponding to the utterance content uttered by the utterer at a timing when the listener makes the expression. This is because it is considered that the listener does not understand in a case where the listener has the bothered expression. The portions that the listener would not understand are emphasized, and thus, the listener can easily understand.

The bothered expression of the listener can be detected by performing known expression recognition processing on the video data. The keywords uttered by the listener, the predetermined motion of the listener, the expression of the listener, and the like correspond to the reaction of the listener in the claims.

As described above, whether or not to add the emphasis supplement information to the document can be determined by a plurality of methods. The determination may be performed by using all methods, or may be performed by using any one method or any plurality of methods.

The description returns to the flowchart of FIG. 6. In a case where it is determined to add the emphasis supplement information to the document, the processing proceeds from step S108 to step S109 (Yes in step S108).

Subsequently, in step S109, the supplement information determining unit 361 determines to add the emphasis supplement information to the document.

Moreover, the supplement information determining unit 361 determines the method for adding the emphasis supplement information.

Examples of the method for adding the emphasis supplement information include changing the size, color, and font of characters in the document, and decorating characters in the document (for example, an underline is drawn, characters, figures, illustrations, and the like in the document are surrounded by a figure such as a circle, and the like). Furthermore, in a case where the listener terminal device 200 has a function of vibrating a housing, the information processing device 300 instructs the listener terminal device 200 to vibrate, and the listener terminal device 200 vibrates the housing. Accordingly, the character string can be emphasized.

The determination of the emphasis method is performed on the basis of the document analysis information obtained by analyzing the document by the document analysis unit 340, the first listener information, the second listener information, and the like.

For example, in a case where it is grasped that a specific matter, for example, a matter related to the person under age is represented in a specific color in the document while referring to the document analysis information and it is found that the listener is the person under age while referring to the first listener information, a method for applying the specific color to a character indicating the matter related to the person under age is determined as the emphasis method.

Furthermore, in a case where the matter related to the person under age is set to be emphasized in a specific color in advance, and in a case where it is found that the listener is the person under age while referring to the first listener information, a method for applying the specific color to the character indicating the matter related to the person under age is determined as the emphasis method.

Furthermore, in a case where the decoration of the character is already applied in the document, the emphasis method is determined not to cover the decoration. For example, in a case where the size of the character is already larger than the other characters, the emphasis method is determined to be a method other than a method for “enlarging character”, for example, “changing color of character”.

Furthermore, the emphasis method can be determined in accordance with what kind of person the listener is while referring to the first listener information. For example, in a case where the listener is a person with color blindness, a method for increasing the size of the character string instead of changing the color of the character string is determined as the emphasis method. Furthermore, in a case where the listener is an elderly person of a predetermined age or more, a method for increasing the size of the character string is determined as the emphasis method. Alternatively, in a case where the character string in the document is already enlarged for the elderly, a method other than enlarging the character, for example, a method for coloring the character string is determined as the emphasis method.

Furthermore, the emphasis method can be determined in accordance with the type of the listener terminal device 200. For example, in a case where a size of a display unit 205 of the listener terminal device 200 is equal to or less than a predetermined size, a method other than increasing the size of the character, for example, a method for coloring the character or a method for decorating the character is determined as the emphasis method.

The emphasis method is automatically determined on the basis of various types of information as described above, but the utterer or the listener may set the emphasis method in advance. For example, in a case where the emphasis method is determined in advance to enlarge the character for a specific item, priority is given to the emphasis method for enlarging the character of the specific item regardless of the determination of the emphasis method based on the document analysis information, the first listener information, the second listener information, and the like as described above.

The description returns to the flowchart of FIG. 6. Subsequently, in step S110, the supplement information adding unit 363 adds the utterance position supplement information and the emphasis supplement information to the document to create the document with supplement information. Then, the document with supplement information is transmitted to the listener terminal device 200. The document with supplement information is displayed on the display unit 205 of the listener terminal device 200, and thus, the listener can view the document with supplement information in which the position corresponding to the utterance content of the utterer is indicated and which is further emphasized.

Note that, the information processing device 300 may also transmit the document with supplement information to the utterer terminal device 100, and the document with supplement information may be displayed on the display unit 105 of the utterer terminal device 100. Consequently, the utterer can also view the document with supplement information in which the position corresponding to the utterance content of the utterer is indicated and which is further emphasized.

On the other hand, in step S107, in a case where the supplement information determining unit 361 determines not to add the emphasis supplement information to the document, the processing proceeds from step S108 to step S111 (No in step S108).

In step S111, the supplement information adding unit 363 adds the utterance position supplement information to the document to create the document with supplement information. Then, the document with supplement information to which the utterance position supplement information is added is transmitted to the listener terminal device 200. The document with supplement information is displayed on the display unit 205 in the listener terminal device 200, and thus, the listener can view the document with supplement information indicating the position corresponding to the utterance content of the utterer.

Note that, the information processing device 300 may also transmit the document with supplement information to the utterer terminal device 100, and the document with supplement information may be displayed on the display unit 105 in the utterer terminal device 100. Therefore, the utterer can also view the document with supplement information indicating the position corresponding to the utterance content of the utterer.

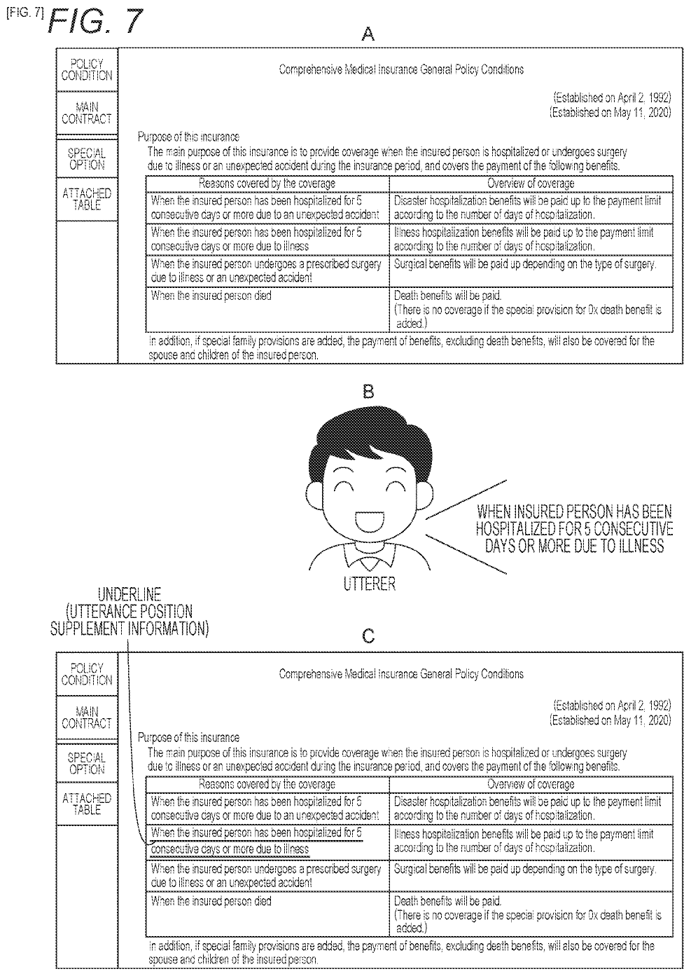

Here, specific examples of the addition of the utterance position supplement information and the addition of the emphasis supplement information will be described. For example, as illustrated in FIG. 7A, there is a character string “when the insured person has been hospitalized for five consecutive days or more due to illness” in the document, and as illustrated in FIG. 7B, the utterer utters the same content as the character string of the document “when the insured person has been hospitalized for five consecutive days or more due to illness”. In this case, since the utterance content information of the utterer coincides the character string in the document, the utterance position supplement information is added to the character string in the document as illustrated in FIG. 7C. In FIG. 7C, the utterance position supplement information is underlined. Therefore, the listener can easily grasp which portion in the document the utterer has uttered. Note that, since the utterance position supplement information indicates which part of the document the utterer is currently uttering about, the utterance position supplement information automatically disappears when a predetermined time elapses.

As described above, the utterance position supplement information can be added by the method for enlarging the character, changing the color of the character, changing the font of the character, superimposing an icon, or the like, in addition to underlining.

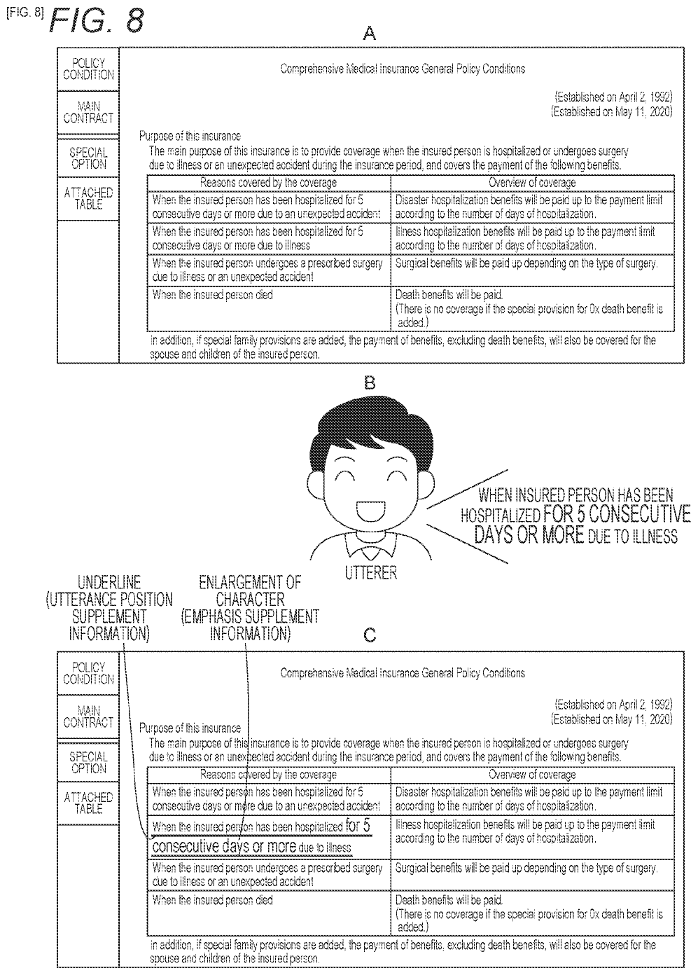

Furthermore, as illustrated in FIG. 8A, there is a character string “when the insured person has been hospitalized for five consecutive days or more due to illness” in the document, and as illustrated in FIG. 8B, the utterer utters the same content as the character string of the document “when the insured person has been hospitalized for five consecutive days or more due to illness”. Moreover, the words “five days or more” are uttered in a loud voice during the utterance. In this case, as illustrated in FIG. 8C, the utterance position supplement information is added to the document in an underlined manner, and the character string in the document corresponding to the utterance content “five days or more” is further increased to add the emphasis supplement information. Consequently, the listener can easily grasp that the portion where the utterer has uttered is important. Note that, since the emphasis supplement information indicates an important portion in the document, unlike the utterance position supplement information, the emphasis supplement information may be left without disappearing even after a predetermined time elapses.

Note that, both the addition of the utterance position supplement information and the addition of the emphasis supplement information can be performed by changing the size, color, and font of the character, decorating the character (for example, an underline is drawn, characters, figures, illustrations, and the like in the document are surrounded by a figure such as a circle, and the like), or the like. However, in order to distinguish the utterance position supplement information from the emphasis supplement information, as illustrated in FIG. 8C, the addition of the utterance position supplement information and the addition of the emphasis supplement information may be performed by different methods.

The description returns to the flowchart of FIG. 6. As a result of comparing the utterance content information of the utterer with the document by the utterance content comparison unit 350, in a case where the utterance content does not correspond to the character string in the document, the processing proceeds from step S104 to step S112 (No in step S104).

Subsequently, in step S112, the supplement information determining unit 361 determines that the utterance content supplement information indicating the utterance content that does not correspond to the character string in the document is supplement information to be added to the document.

Subsequently, in step S113, the supplement information position determining unit 362 determines a display position when the utterance content supplement information is added to the document. An addition position of the utterance content supplement information is, for example, a page displayed when the utterer is uttering, the vicinity of a position where words related to the utterance content of the utterer are present in the document, or the like.

In step S114, the supplement information adding unit 363 adds the utterance content supplement information to the document to create the document with supplement information.

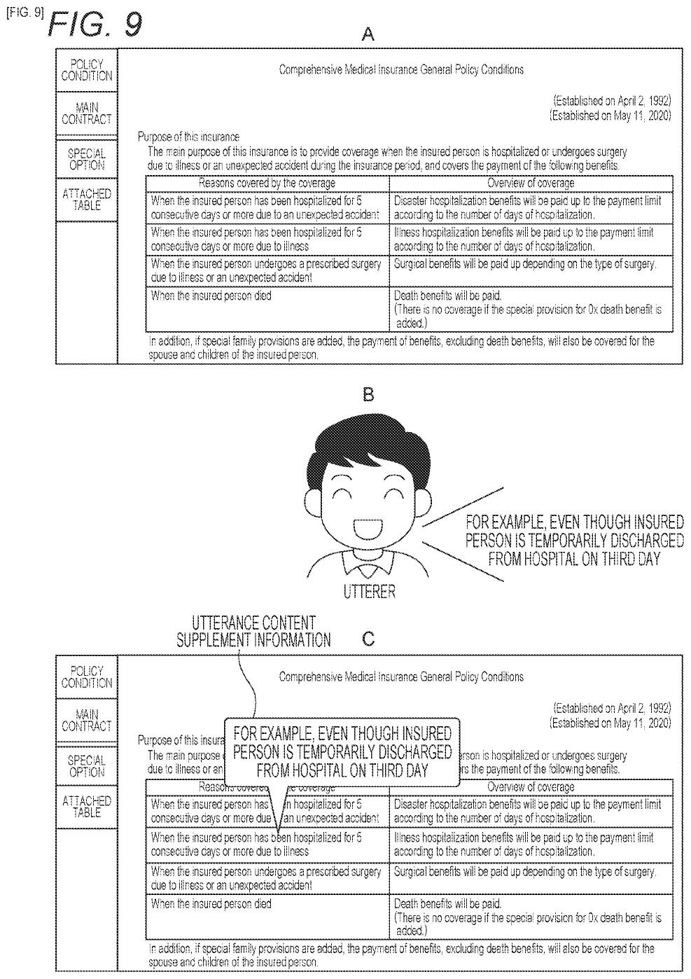

For example, the utterer utters “for example, even though the insured person is temporarily discharged from the hospital on the third day” as illustrated in FIG. 9B, and the utterance content does not correspond to the character string in the document illustrated in FIG. 9A. In this case, as illustrated in FIG. 9C, the utterance content is added to the document as the utterance content supplement information.

In the example of FIG. 9C, the utterance content supplement information is represented as characters in a balloon-shaped icon, but a mode of the utterance content supplement information is not limited thereto. For example, a window different from the document may be displayed, and the utterance content may be displayed in the window.

Then, the document with supplement information to which the utterance content supplement information is added is transmitted to the listener terminal device 200. The document with supplement information is displayed on the display unit 205 in the listener terminal device 200, and thus, the listener can view the document with supplement information to which the utterance content information is added.

Note that, the information processing device 300 may also transmit the document with supplement information to the utterer terminal device 100, and the document with supplement information may be displayed on the display unit 105 in the utterer terminal device 100. Therefore, the utterer can also view the document with supplement information indicating the position corresponding to the utterance content of the utterer.

As described above, the processing by the information processing device 300 according to the first embodiment is performed. In the first embodiment, the following effects can be obtained.

The utterance position supplement information indicating the character string in the document corresponding to the utterance content of the utterer is indicated as the supplement information, and thus, the listener can easily grasp which part in the document the utterer is currently uttering. Furthermore, the listener can grasp a portion where the utterer is not uttering, a portion where the utterance is missing, and a portion where the utterance is skipped.

Furthermore, the utterance content not described in the document is added, as the supplement information, to the document, and thus, the listener and the utterer can confirm the utterance content of the utterer not described in the document even after the conversation.

Furthermore, the listener may be on the utterance side, and the utterer may be on the listening side. The listener on the utterance side may read an important matter in the document, and the utterer terminal device 100 may display the document to which the supplement information for specifying the character string corresponding to the utterance content of the listener is added. Therefore, the utterer can skip or grasp a portion that the listener has misread.

Furthermore, it is possible to change a sentence that is difficult to understand and written in a difficult word in the document into an expression that is easier to understand for the utterance content of the utterer, and leave the expression as the supplement information to be added to the document as the character.

Furthermore, since the utterance content of the utterer is added, as the supplement information, to the document and the supplement information based on an utterance method (accent, utterance speed, and the like) is further added to the document, characteristics of the utterance method of the utterer, utterance skill, a difference in the utterance method from other persons, and the like can be understood from the document.

In the related, when utterance methods of a beginner and an advanced-level person are compared, an utterance state is imaged as a video, but it is difficult to accurately compare the utterance methods even though an imaged moving image is viewed. On the other hand, in the present technology, since the supplement information based on the utterance content and the utterance method (accent, utterance speed, and the like) of the utterer is added to the document, the utterance methods of the beginner and the advanced-level person can be easily compared by comparing the pieces of supplement information of the document of the beginner and the advanced-level person.

### 2. Second Embodiment

### [2-1. Configuration of Information Processing Device 300]

Next, a second embodiment of the present technology will be described. Configurations of a conversation system 10, an utterer terminal device 100, and a listener terminal device 200 and an outline of conversation between an utterer and a listener are similar to those described in the first embodiment.

In the utterer terminal device 100 that displays a document on a display unit 105, a display range of the document can be voluntarily changed by an input from the utterer to the utterer terminal device 100. This is a function normally provided in an application for displaying data such as a document in a personal computer, a smartphone, a tablet terminal, or the like. The utterer terminal device 100 continues to transmit information (referred to as utterer display range information) indicating a display range of a current document of the utterer terminal device to an information processing device 300 at all times or at predetermined time intervals. The same applies to the listener terminal device 200. Information indicating the display range of the document on the listener terminal device 200 is referred to as listener display range information.

In the second embodiment, display range supplement information indicating which range of the document is displayed on the listener terminal device 200 is added, as supplement information, to the document.

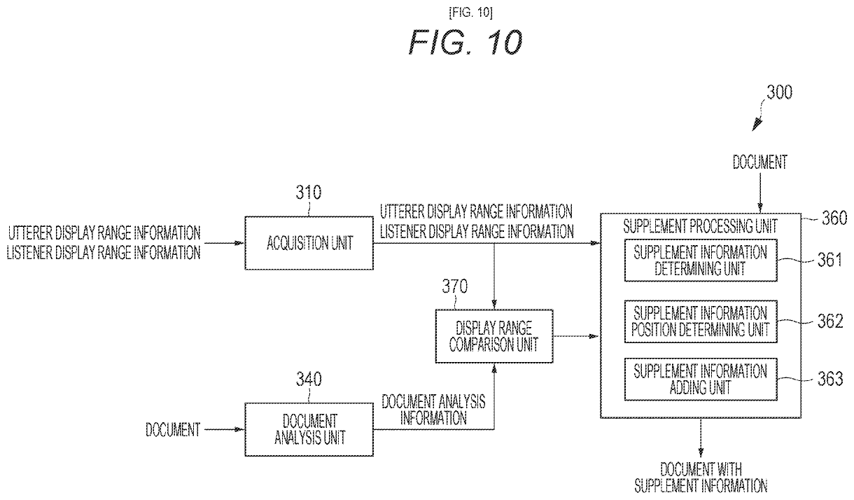

As illustrated in FIG. 10, the information processing device 300 includes an acquisition unit 310, a document analysis unit 340, a display range comparison unit 370, and a supplement processing unit 360.

The acquisition unit 310 acquires the utterer display range information transmitted from the utterer terminal device 100 and the listener display range information transmitted from the listener terminal device 200. The acquisition unit 310 supplies the utterer display range information and the listener display range information to the supplement processing unit 360 and the display range comparison unit 370.

As in the first embodiment, the document analysis unit 340 analyzes the document displayed on the utterer terminal device 100 and the listener terminal device 200 to acquire document analysis information. The document analysis unit 340 supplies the document itself and the document analysis information to the display range comparison unit 370.

The display range comparison unit 370 compares the display range of the document on the utterer terminal device 100 with the display range of the document on the listener terminal device 200 on the basis of the document analysis information, the utterer display range information, and the listener display range information, and determines whether or not these display ranges are the same. Furthermore, in a case where the display range of the document on the utterer terminal device 100 is not the same as the display range of the document on the listener terminal device 200, it is determined whether or not the display range of the document on the listener terminal device 200 is included in the display range of the document on the utterer terminal device 100.

Note that, “the display range of the listener terminal device 200 is included within the display range of the utterer terminal device 100” may be only a case where the entire display range of the listener terminal device 200 is included in the display range of the utterer terminal device 100, or may be a case where a part of the display range of the listener terminal device 200 is included in the display range of the utterer terminal device 100.

The supplement processing unit 360 determines the supplement information to be added to the document, and adds the supplement information to the document to create a document with supplement information. The supplement processing unit 360 includes a supplement information determining unit 361, a supplement information position determining unit 362, and a supplement information adding unit 363.

The supplement information determining unit 361 determines the supplement information to be added to the document. In the second embodiment, the display range supplement information indicating the display range of the document on the listener terminal device 200 is determined as the supplement information. The display range supplement information is represented by, for example, a frame surrounding the display range.

The supplement information position determining unit 362 determines a disposition position when the display range supplement information is added to the document. The display range supplement information is disposed at a position in the document displayed on the utterer terminal device 100, which coincides the display range displayed on the listener terminal device 200.

The supplement information adding unit 363 adds the display range supplement information to the document to create the document with supplement information.

The information processing device 300 has the above-described configuration. In addition to a server device 400, the information processing device 300 may operate in an electronic device such as a cloud, a smartphone, or a personal computer, or may be implemented by causing a computer to execute a program as in the first embodiment.

### [2-2. Processing in Information Processing Device 300]

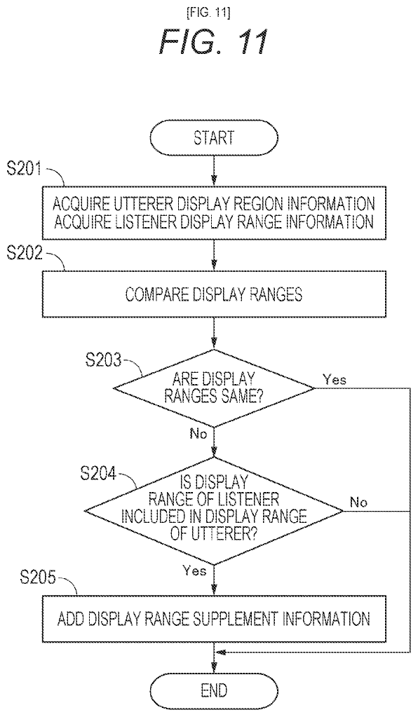

Next, processing by the information processing device 300 according to the second embodiment will be described with reference to FIG. 11.

First, in step S201, the acquisition unit 310 acquires the utterer display range information transmitted from the utterer terminal device 100 and the listener display range information transmitted from the listener terminal device 200.

Subsequently, in step S202, the display range comparison unit 370 compares the display range on the utterer terminal device 100 with the display range on the listener terminal device 200 on the basis of the document analysis information, the utterer display range information, and the listener display range information. The comparison of the display ranges can be performed by a method for comparing text data indicating characters included within the display ranges, treating the display ranges as images, and comparing the display ranges by known block matching, or the like.

In a case where the display range on the utterer terminal device 100 and the display range on the listener terminal device 200 are not the same, the processing proceeds from step S203 to step S204 (No in step S203).

Subsequently, in step S204, in a case where the display range of the listener terminal device 200 is included within the display range of the utterer terminal device 100, the processing proceeds to step S205 (Yes in step S204).

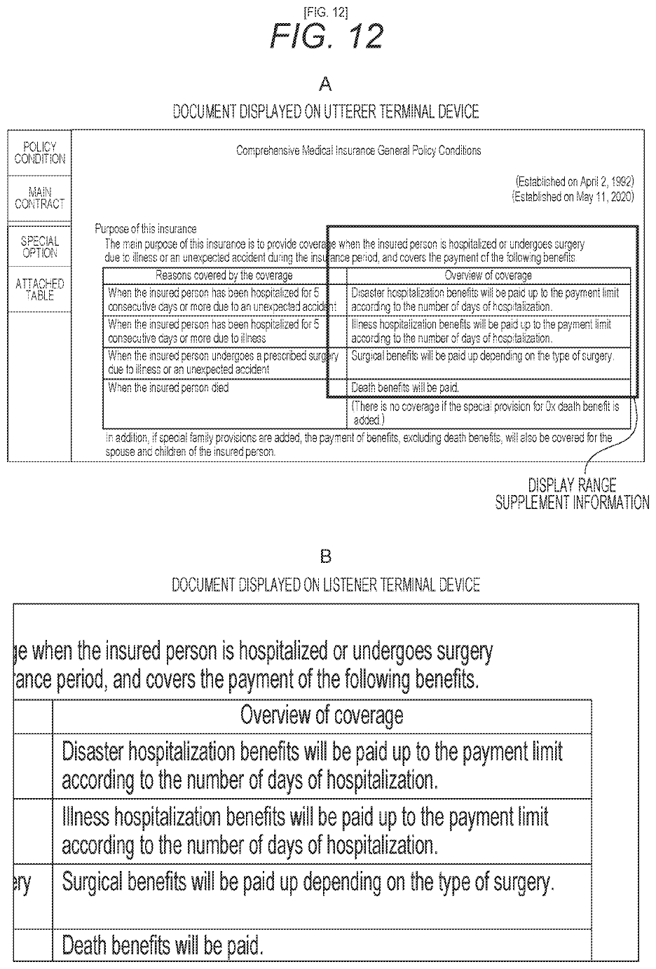

Subsequently, in step S205, the supplement information adding unit 363 adds, to the document, the display range supplement information indicating the display range on the listener terminal device 200. For example, in a case where FIG. 12A illustrates the display range of the document on the listener terminal device 200 and FIG. 12B illustrates the display range of the document on the utterer terminal device 100, the display range supplement information is added to the document as a frame indicating the display range on the listener terminal device 200 as illustrated in FIG. 12A.

Then, the document with supplement information to which the display range supplement information is added is transmitted to the utterer terminal device 100. The document with supplement information is displayed on the display unit 105 in the utterer terminal device 100, and thus, the utterer can grasp which part of the document is currently displayed on the listener terminal device 200.

Note that, the utterer terminal device 100 may input the document with supplement information to which the display range supplement information is added, and the display range of the document on the listener terminal device 200 may be changed on the basis of the input. Therefore, the utterer can show the listener any region in the document.

Thus, a position and a size of the frame as the display range supplement information displayed on the utterer terminal device 100 can be voluntarily changed by the input to the utterer terminal device 100. Then, the information processing device 300 changes the display range of the document on the basis of the change information of the frame, and transmits the document of which the display range is changed to the listener terminal device 200. The display range may be changed only in a case where the listener permits the change.

As described above, the processing by the information processing device 300 according to the second embodiment is performed. According to the second embodiment, since the supplement information indicating which region of the document is currently displayed on the listener terminal device 200 is added to the document, the utterer can confirm which range of the document is displayed on the listener terminal device 200.

In the first embodiment, it is assumed that the same or substantially the same range of the document is displayed on the utterer terminal device 100 and the listener terminal device 200, but different ranges of the document may be displayed on the utterer terminal device 100 and the listener terminal device 200. For example, there are a case where the listener wants to view ahead of the document since the listener understands the utterance content of the utterer, a case where the listener views another portion of the document since the listener cannot understand the utterance content of the utterer, and the like. In the second embodiment, even in such a case, the utterer can grasp which part in the document the listener is currently viewing.

### 3. Third Embodiment

### [3-1. Configuration of Information Processing Device 300]

Next, a third embodiment of the present technology will be described. Configurations of a conversation system 10, an utterer terminal device 100, and a listener terminal device 200 and an outline of conversation between an utterer and a listener are similar to those described in the first embodiment.

Note that, as in the second embodiment, in the listener terminal device 200 that displays a document on a display unit 205, a display range of the document can be voluntarily changed by an input from the listener to the listener terminal device 200. The listener terminal device 200 continues to transmit information (referred to as listener display range information) indicating a display range of a current document of the utterer terminal device to the information processing device 300 at all times or at predetermined time intervals.

In the third embodiment, notification supplement information for notifying the listener that the character string coinciding the utterance content of the utterer is present outside the display range of the document on the listener terminal device 200 is added, as supplement information, to the document.

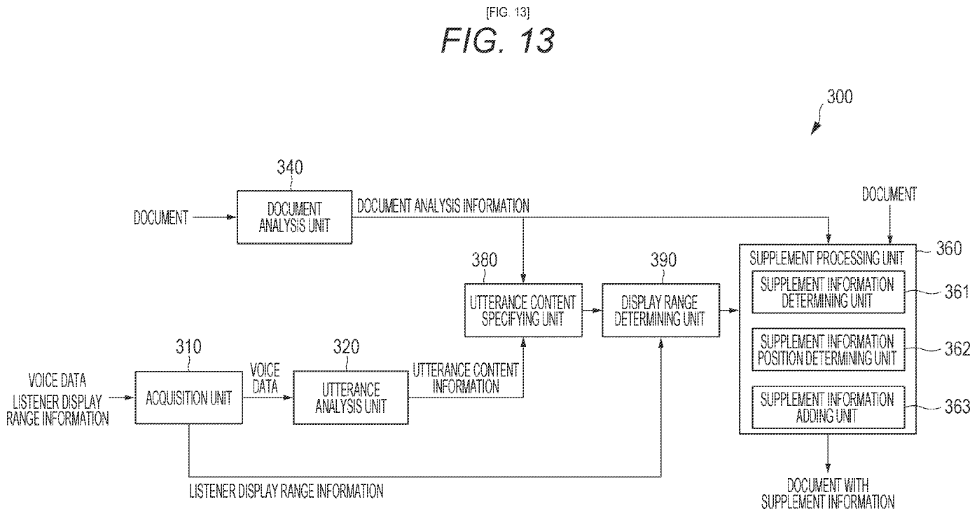

As illustrated in FIG. 13, the information processing device 300 includes an acquisition unit 310, an utterance analysis unit 320, a document analysis unit 340, an utterance content specifying unit 380, a display range determining unit 390, and a supplement processing unit 360.

The acquisition unit 310 acquires the listener display range information indicating the display range of the document on the listener terminal device 200 transmitted from the listener terminal device 200, and supplies the listener display range information to the display range determining unit 390. Furthermore, the acquisition unit 310 acquires voice data of the utterer transmitted from the utterer terminal device 100 and supplies the voice data to the utterance analysis unit 320.

As in the first embodiment, the utterance analysis unit 320 analyzes the voice data transmitted from the utterer terminal device 100 to acquire utterance content information and utterance related information of the utterer, and supplies the utterance content information and the utterance related information to the utterance content specifying unit 380.

As in the first embodiment, the document analysis unit 340 analyzes the document displayed on the utterer terminal device 100 and the listener terminal device 200 to acquire document analysis information. The document analysis unit 340 supplies the document analysis information to the utterance content specifying unit 380 and the supplement processing unit 360.

The utterance content specifying unit 380 compares the utterance content of the utterer with the content of the document on the basis of the utterance content information, and specifies a character string in the document corresponding to the utterance content. A method for comparing the utterance content with the document is similar to that in the first embodiment. The utterance content specifying unit 380 supplies the specification result to the display range determining unit 390.

The display range determining unit 390 determines whether or not the character string corresponding to the utterance content is present outside the display range by comparing the document with the display range on the listener terminal device 200 on the basis of the character string in the document specified by the utterance content specifying unit 380 and the listener display range information.

The supplement processing unit 360 adds supplement information to the document to creates a document with supplement information. The created document with supplement information is transmitted to the listener terminal device 200. The supplement processing unit 360 includes a supplement information determining unit 361, a supplement information position determining unit 362, and a supplement information adding unit 363.

The supplement information determining unit 361 determines the supplement information to be added to the document. In the third embodiment, notification supplement information for notifying that there is the character string corresponding to the utterance content of the utterer outside the display range of the document on the listener terminal device 200 is determined as the supplement information.

The supplement information position determining unit 362 determines a disposition position when the notification supplement information is added to the document. The notification supplement information is disposed in the vicinity of the character string corresponding to the utterance content of the utterer in the document displayed on the listener terminal device 200.

The supplement information adding unit 363 adds, to the document, notification supplement information for notifying the listener that there is the character string corresponding to the utterance content information outside the display range of the listener terminal device 200 to create a document with supplement information.

### [3-2. Processing in Information Processing Device 300]

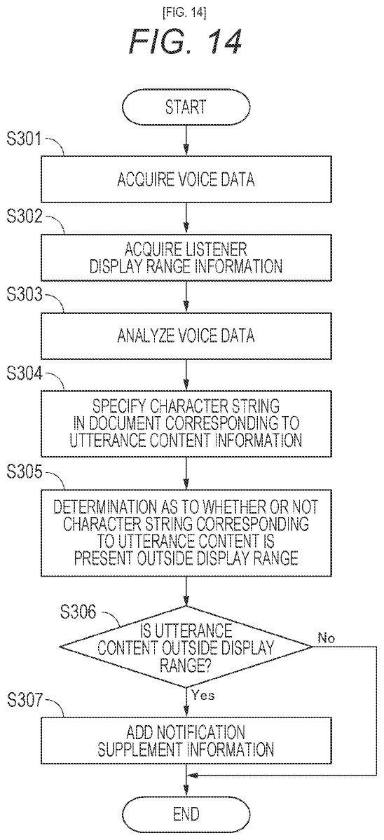

Next, processing by the information processing device 300 according to the third embodiment will be described with reference to FIG. 14.

Note that, before the processing illustrated in FIG. 14, a document in an initial state input to the information processing device 300 is transmitted to the utterer terminal device 100 and the listener terminal device 200, and the document in the initial state is displayed on the utterer terminal device 100 and the listener terminal device 200. Furthermore, the analysis processing is performed on the document by the document analysis unit 340 in advance, and document analysis information is acquired.

When the utterer makes an utterance related to the document, the voice data acquired by the microphone 107 is transmitted from the utterer terminal device 100 to the information processing device 300. In step S301, the acquisition unit 310 acquires the voice data. The acquisition unit 310 supplies the voice data to the utterance analysis unit 320.

Furthermore, in step S302, the acquisition unit 310 acquires the listener display range information transmitted from the listener terminal device 200. The acquisition unit 310 supplies the listener display range information to the display range determining unit 390. Note that, steps S301 and S302 may not be performed in this order, and may be performed in a reverse order or may be performed substantially simultaneously.

Subsequently, in step S303, the utterance analysis unit 320 analyzes the voice data of the utterer, and acquires utterance content information and utterance related information of the utterer.

Subsequently, in step S304, the utterance content specifying unit 380 specifies the character string in the document corresponding to the utterance content information.

Subsequently, in step S305, the display range determining unit 390 determines whether or not the character string corresponding to the utterance content is present outside the display range on the basis of the character string in the document specified as corresponding to the utterance content information and the listener display range information. As a result of the determination, in a case where the character string corresponding to the utterance content is present outside the display range, the processing proceeds from step S306 to step S307 (Yes in step S306).

Subsequently, in step S307, the supplement information adding unit 363 adds the notification supplement information to the document.

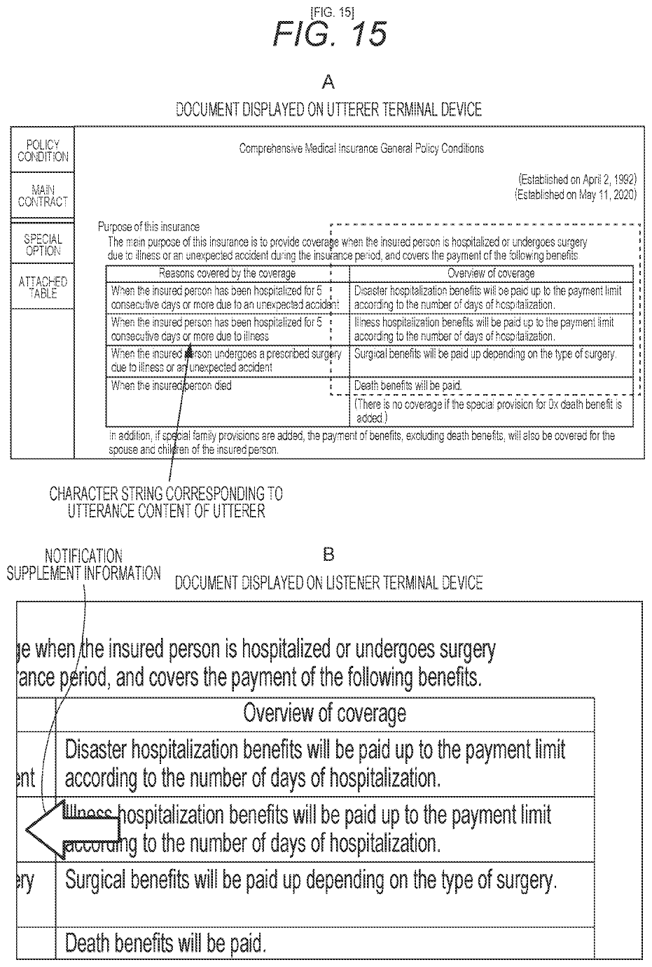

For example, in a case where the document displayed on the utterer terminal device 100 is as illustrated in FIG. 15A and the display range of the document on the listener terminal device 200 is as indicated by a broken line in FIG. 15A and is as illustrated in FIG. 15B, the notification supplement information is added to the document displayed on the listener terminal device 200 as illustrated in FIG. 15B. The notification supplement information indicates a position where the character string corresponding to the utterance content of the utterer is present in the document, and is represented by, for example, an arrow icon. Note that, the broken line in FIG. 15A is for indicating the display range on the listener terminal device 200 for the sake of description, and is not actually displayed on the utterer terminal device 100.

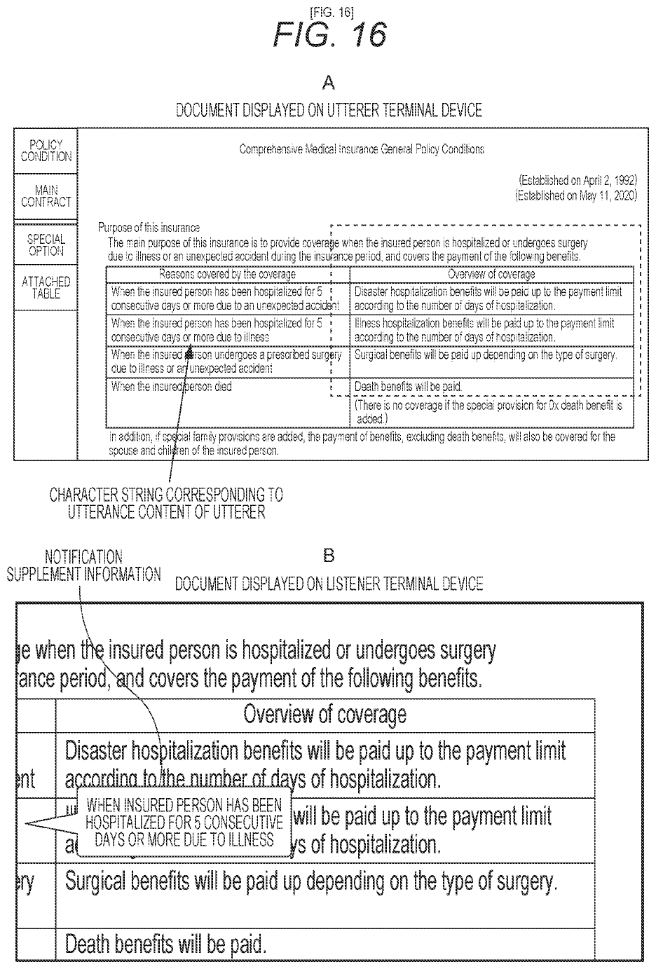

Furthermore, as illustrated in FIG. 16, the notification supplement information may include the position where the character string corresponding to the utterance content of the utterer is present and a balloon-shaped icon indicating the utterance content of the utterer. Furthermore, when the input is performed to the notification supplement information, the display range of the document on the listener terminal device 200 may transition to a range in which the character string coinciding the utterance content of the utterer is present.

As described above, the processing by the information processing device 300 according to the third embodiment is performed. According to the third embodiment, it is possible to notify the listener of an appropriate range in the document corresponding to the utterance content of the utterer and prompt the listener to display the range in the document corresponding to the utterance content.

The present technology is useful for remote consultation, remote meeting, remote counselling, and the like using a video call application in any of the first to third embodiments.

### 4. Modifications

Although the embodiments of the present technology have been specifically described above, the present technology is not limited to the above-described embodiments, and various modifications based on the technical idea of the present technology can be made.

In the embodiments, the case where the utterer unilaterally gives explanation to the listener has been described as an example, but the present technology can also be used in a case where standpoints of two or more persons are switched between the utterer and the listener due to the flow of the utterance.

Furthermore, the present technology is not limited to a case where the video call application by Internet connection is used, and can also be used in the case of face-to-face or in the case of conversation between persons in the same space (same room, same conference room, or the like).

Although the first, second, and third embodiments have been described in the embodiments, the information processing device 300 may perform all of the first to third embodiments on the document instead of performing only the processing of any of the embodiments.

Furthermore, the information processing device 300 may perform the processing of the first and second embodiments on the document, may perform the processing of the first and third embodiments on the document, or the information processing device 300 may perform the processing of the second and third embodiments on the document.

The present technology can also have the following configurations.
(1)
An information processing device including:
a supplement processing unit that adds supplement information to a document displayed on an utterer terminal device used by an utterer and a listener terminal device used by a listener who performs conversation with the utterer in accordance with information regarding the conversation or the document.
(2)
The information processing device according to (1), in which in a case where an utterance content of the utterer and a character string in the document do not correspond, the supplement processing unit adds, to the document, utterance content supplement information indicating the utterance content.
(3)
The information processing device according to (1) or (2), in which in a case where the utterance content corresponds to a character string in the document, the supplement processing unit adds, to the document, utterance position supplement information indicating the character string in the document corresponding to the utterance content of the utterer.
(4)
The information processing device according to any one of (1) to (3), in which the supplement processing unit adds, to the document, emphasis supplement information for emphasizing a character string in the document.
(5)
The information processing device according to (4), in which in a case where magnitude of voice of utterance of the utterer as the information regarding the conversation is equal to or more than a predetermined value, the emphasis supplement information is added to the document.
(6)
The information processing device according to (4) or (5), in which in a case where a speed of utterance of the utterer as the information regarding the conversation is equal to or less than a predetermined value, the emphasis supplement information is added to the document.
(7)
The information processing device according to any one of (4) to (6), in which in a case where a predetermined keyword is included in an utterance content of the utterer as the information regarding the conversation, the emphasis information is added to the document.
(8)
The information processing device according to any one of (4) to (7), in which in a case where a reaction of the listener as information regarding the conversation is a predetermined reaction, the emphasis supplement information is added to the document.
(9)
The information processing device according to any one of (1) to (8) including: an utterance content comparison unit that determines whether or not utterance content information of the utterer as information regarding the conversation corresponds to a character string in the document.
(10)
The information processing device according to any one of (1) to (9), in which the supplement processing unit adds, to the document, display range supplement information indicating a display range of the document on the listener terminal device in a display range of the document on the utterer terminal device.
(11)
The information processing device according to (10) including: a display range comparison unit that specifies the display range of the document on the listener terminal device within the display range of the document on the utterer terminal device by comparing utterer display range information indicating the display range of the document on the utterer terminal device with listener display range information indicating the display range of the document on the listener terminal device.
(12)
The information processing device according to (10) or (11), in which the document to which the display range supplement information is added is displayed on the utterer terminal device.
(13)
The information processing device according to any one of (10) to (12), in which the display range supplement information is changed a display range of a document with the supplement information on the listener terminal device is changed in accordance with the change.
(14)
The information processing device according to any one of (1) or (13), in which the supplement processing unit adds, to the document, notification supplement information for notifying that a character string coinciding an utterance content of the utterer is present outside a display range of the document on the listener terminal device.
(15)
The information processing device according to (14) including:
an utterance content specifying unit that specifies the character string in the document corresponding to the utterance content of the utterer; and
a display range determining unit that determines whether or not the character string in the document corresponding to the utterance content specified by the utterance content specifying unit is present outside the display range of the document on the listener terminal device.
(16)
The information processing device according to (14), in which the document to which the notification supplement information is added is displayed on the listener terminal device.
(17)
The information processing device according to (14), in which when an input is performed for the notification supplement information, the display range of the document on the listener terminal device transitions to a range in which the character string coinciding the utterance content of the utterer is present.
(18)
An information processing method including:
adding supplement information to a document displayed on an utterer terminal device used by an utterer and a listener terminal device used by a listener who performs conversation with the utterer in accordance with information regarding the conversation or the document.
(19)
A program causing a computer to execute an information processing method of:
adding supplement information to a document displayed on an utterer terminal device used by an utterer and a listener terminal device used by a listener who performs conversation with the utterer in accordance with information regarding the conversation or the document.

### REFERENCE SIGNS LIST

100 Utterer terminal device
200 Listener terminal device
300 Information processing device
350 Utterance content comparison unit
360 Supplement processing unit
370 Display range comparison unit
380 Utterance content specifying unit
390 Display range determining unit

1. An information processing device comprising:
a supplement processing unit that adds supplement information to a document displayed on an utterer terminal device used by an utterer and a listener terminal device used by a listener who performs conversation with the utterer in accordance with information regarding the conversation or the document.

2. The information processing device according to claim 1, wherein
in a case where an utterance content of the utterer and a character string in the document do not correspond, the supplement processing unit adds, to the document, utterance content supplement information indicating the utterance content.

3. The information processing device according to claim 1, wherein
in a case where the utterance content corresponds to a character string in the document, the supplement processing unit adds, to the document, utterance position supplement information indicating the character string in the document corresponding to the utterance content of the utterer.

4. The information processing device according to claim 1, wherein
the supplement processing unit adds, to the document, emphasis supplement information for emphasizing a character string in the document.

5. The information processing device according to claim 4, wherein
in a case where magnitude of voice of utterance of the utterer as the information regarding the conversation is equal to or more than a predetermined value, the emphasis supplement information is added to the document.

6. The information processing device according to claim 4, wherein
in a case where a speed of utterance of the utterer as the information regarding the conversation is equal to or less than a predetermined value, the emphasis supplement information is added to the document.

7. The information processing device according to claim 4, wherein
in a case where a predetermined keyword is included in an utterance content of the utterer as the information regarding the conversation, the emphasis information is added to the document.

8. The information processing device according to claim 4, wherein
in a case where a reaction of the listener as information regarding the conversation is a predetermined reaction, the emphasis supplement information is added to the document.

9. The information processing device according to claim 1, comprising:
an utterance content comparison unit that determines whether or not utterance content information of the utterer as information regarding the conversation corresponds to a character string in the document.

10. The information processing device according to claim 1, wherein
the supplement processing unit adds, to the document, display range supplement information indicating a display range of the document on the listener terminal device in a display range of the document on the utterer terminal device.

11. The information processing device according to claim 10, comprising:
a display range comparison unit that specifies the display range of the document on the listener terminal device within the display range of the document on the utterer terminal device by comparing utterer display range information indicating the display range of the document on the utterer terminal device with listener display range information indicating the display range of the document on the listener terminal device.

12. The information processing device according to claim 10, wherein
the document to which the display range supplement information is added is displayed on the utterer terminal device.

13. The information processing device according to claim 10, wherein
when the display range supplement information is changed, a display range of a document with the supplement information on the listener terminal device is changed in accordance with the change.

14. The information processing device according to claim 1, wherein
the supplement processing unit adds, to the document, notification supplement information for notifying that a character string coinciding an utterance content of the utterer is present outside a display range of the document on the listener terminal device.

15. The information processing device according to claim 14, comprising:
an utterance content specifying unit that specifies the character string in the document corresponding to the utterance content of the utterer; and
a display range determining unit that determines whether or not the character string in the document corresponding to the utterance content specified by the utterance content specifying unit is present outside the display range of the document on the listener terminal device.

16. The information processing device according to claim 14, wherein
the document to which the notification supplement information is added is displayed on the listener terminal device.

17. The information processing device according to claim 14, wherein
when an input is performed for the notification supplement information, the display range of the document on the listener terminal device transitions to a range in which the character string coinciding the utterance content of the utterer is present.

18. An information processing method comprising:
adding supplement information to a document displayed on an utterer terminal device used by an utterer and a listener terminal device used by a listener who performs conversation with the utterer in accordance with information regarding the conversation or the document.

19. A program causing a computer to execute an information processing method of:
adding supplement information to a document displayed on an utterer terminal device used by an utterer and a listener terminal device used by a listener who performs conversation with the utterer in accordance with information regarding the conversation or the document.
